(19) United States
(12) Patent Application Publication
(10) Pub. No.: US 2016/0216667 A1
(43) Pub. Date: Jul. 28, 2016

(54) Heating Body, Heating Device, and Image Forming Apparatus

(71) Applicant: FUJI XEROX CO., LTD., Tokyo (JP)

(72) Inventor: Hirokazu TSUBOTA, Kanagawa (JP)

(73) Assignee: FUJI XEROX CO., LTD., Tokyo (JP)

(21) Appl. No.: 14/824,366

(22) Filed: Aug. 12, 2015

(30) Foreign Application Priority Data
Jan. 27, 2015 (JP) 2015-013688

(51) Int. Cl. G03G 15/20

(52) U.S. Cl. CPC G03G 15/2053

(57) ABSTRACT

Provided is a heating body that heats a target heating body that is in contact with an outer periphery thereof, and that is formed in a tubular shape, the heating body including a support body, and a heat-emitting body that is supported by the support body, absorbs light that is transmitted by the support body, and emits heat.

### CROSS-REFERENCE TO RELATED APPLICATIONS

This application is based on and claims priority under 35 USC 119 from Japanese Patent Application No. 2015-013688 filed Jan. 27, 2015.

### BACKGROUND

### Technical Field

The present invention relates to a heating body, a heating device, and an image forming apparatus.

### SUMMARY

According to an aspect of the invention, there is provided a heating body that heats a target heating body that is in contact with an outer periphery thereof, and that is formed in a tubular shape,

the heating body including:

a support body; and

a heat-emitting body that is supported by the support body, absorbs light that is transmitted by the support body, and emits heat.

### BRIEF DESCRIPTION OF THE DRAWINGS

Exemplary embodiments of the present invention will be described in detail based on the following figures, wherein:

FIG. 1 is an outline drawing (a front view) of an image forming apparatus according to a first exemplary embodiment;

FIG. 2 is an outline drawing (a front view) of a fixing device that configures the image forming apparatus according to the first exemplary embodiment;

FIG. 3 is an outline drawing (a side view) of the fixing device that configures the image forming apparatus according to the first exemplary embodiment;

FIG. 4 is a schematic drawing of a portion (a partial sectional view viewed from a front side) of a heating belt that configures a heating device according to the first exemplary embodiment;

FIG. 5 is a schematic drawing (an enlarged view) of a portion of the heating belt that configures the heating device according to the first exemplary embodiment;

FIG. 6 is a schematic drawing that represents a relationship between a minimum irradiation dot of irradiation light that an irradiation device, which configures the heating device according to the first exemplary embodiment, irradiates the heating belt with, and a minimum exposure dot of exposure light that an exposure device according to the first exemplary embodiment exposes a photosensitive drum with;

FIG. 7 is a schematic drawing (flowchart) that represents a flow of processing of image data that is sent from an external device to a control section, which configures the image forming apparatus according to the first exemplary embodiment;

FIG. 8 is a schematic drawing (timing chart) that represents a timing of exposure of the exposure light, which the exposure device according to the first exemplary embodiment exposes, and a timing of irradiation of the irradiation light, which the irradiation device irradiates;

FIG. 9 is a schematic drawing (an enlarged view) of a portion of a belt (which uses carbon black as an example of a heat-emitting body) of a form (a first modification example) that differs from the belt according to the first exemplary embodiment;

FIG. 10 is a schematic drawing (an enlarged view) of a portion of a belt (which uses a graphene film as an example of a heat-emitting body) of a form (a second modification example) that differs from the belt according to the first exemplary embodiment;

FIG. 11 is a schematic drawing (a partial sectional view viewed from a front side) of a belt that configures a heating device according to a second exemplary embodiment;

FIG. 12 is an outline drawing (a front view) of a heating device that configures an image forming apparatus according to a third exemplary embodiment; and

FIG. 13 is an outline drawing (a front view) of a heating device that configures an image forming apparatus according to a fourth exemplary embodiment.

### DETAILED DESCRIPTION

Outline

Hereinafter, four exemplary embodiments (first to fourth exemplary embodiments), which are forms (hereinafter, referred to as exemplary embodiments) for implementing the present invention, will be described with reference to the drawings.

In the following description, a direction that is shown by an arrow X and an arrow −X in the drawings is set as a device width direction, and a direction that is shown by an arrow Y and an arrow −Y in the drawings is set as a device height direction. In addition, directions (directions of an arrow Z and an arrow −Z) that are respectively orthogonal to the device width direction and the device height direction are set as a device depth direction.

### First Exemplary Embodiment

Hereinafter, the present exemplary embodiment will be described. Firstly, a configuration of an image formation apparatus 10 according to the present exemplary embodiment will be described. Next, operations of the image formation apparatus 10 according to the present exemplary embodiment will be described. Subsequently, effects according to the present exemplary embodiment will be described.

Configuration of Image Forming Apparatus

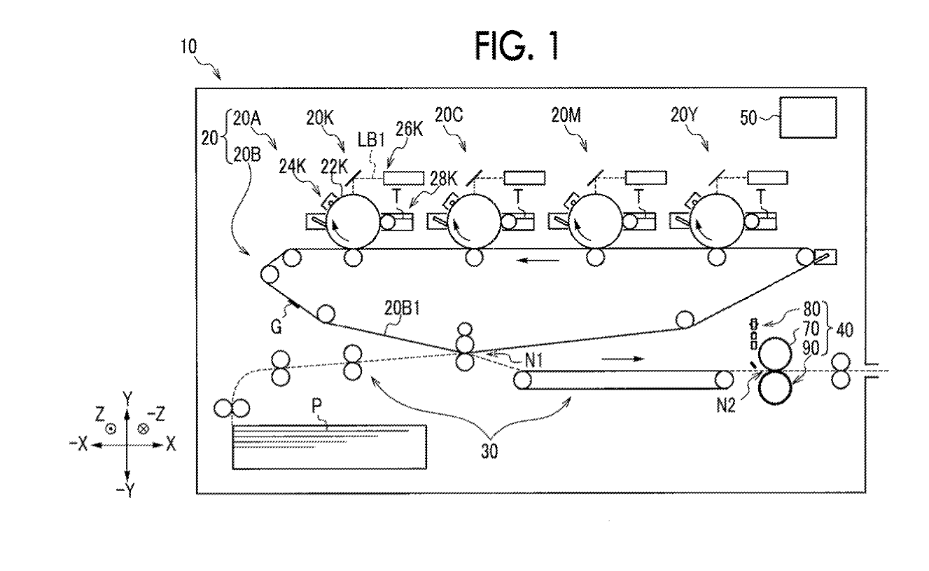

As shown in FIG. 1, the image formation apparatus 10 is set as an electrophotographic type apparatus that is configured to include a toner image formation section 20, a transport device 30, a fixing device 40, and a control section 50.

Toner Image Formation Section

The toner image formation section 20 has a function of forming toner images G, which are configured by a toner T, on a medium P, which is transported, by performing each step of charging, exposure, developing and transfer (a first transfer and a second transfer). In this instance, the toner image formation section 20 is an example of a formation section. The toner images G are an example of an image. The toner image formation section 20 is provided with a photosensitive body unit 20A and a transfer unit 20B.

Photosensitive Body Unit

The photosensitive body unit 20A is configured by single color units 20Y, 20M, 20C, and 20K, which form toner images G of respectively different colors (Y (yellow), M (magenta), C (cyan), and K (black)) on each photosensitive drum 22. Other than the color of the toner images G that are formed in each photosensitive drum 22, the single color units 20Y, 20M, 20C, and 20K are set to have the same configuration. In the following description, the letters (Y, M, C, and K) of the single color units 20Y, 20M, 20C, and 20K will be omitted when it is not necessary to discriminate between the single color units 20Y, 20M, 20C, and 20K and the constituent elements thereof. Each single color unit 20 is configured to include a photosensitive drum 22, a charging device 24, an exposure device 26, and a developing device 28. The photosensitive drum 22 is tubular, and rotates about (in a direction of an arrow in the drawing) a self axis (refers to the axis of the photosensitive drum 22 itself) when the single color unit 20 forms the toner images G.

Exposure Device

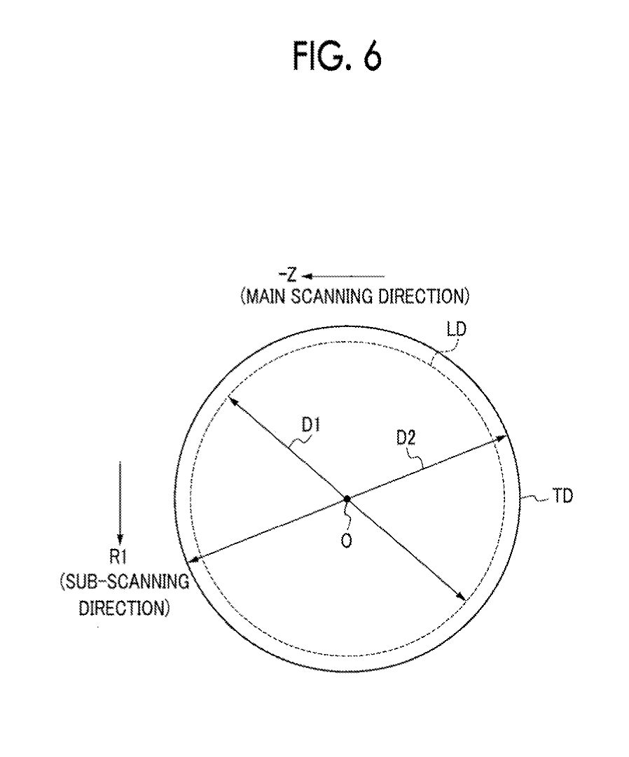

Additionally, the exposure device 26 forms a latent image (not illustrated in the drawings) by exposing the photosensitive drum 22 while scanning in a self axis direction of the photosensitive drum 22 with exposure light LB1 based on exposure data, which will be described below. The resolution of the toner images G, which are fixed to the medium P by the image formation apparatus 10 according to the present exemplary embodiment is set as 1,200×1,200 dpi (dot per inch), as an example. Therefore, the exposure device 26 is configured to be capable of exposing with exposure dots LD with a diameter D1 (corresponds to approximately 21 μm) in a −Z direction and a rotational direction (respectively correspond to a main scanning direction and a sub-scanning direction of the exposure light LB1) of the self axis of the photosensitive drum 22 (refer to FIG. 6).

Transfer Unit

The transfer unit 20B has a function of holding the toner images G of each color, which are formed by each single color unit 20 and primarily transferred, and a function of secondary transferring the toner images G of each color onto the medium P, which is transported, at a nip N1 (FIG. 1). The transfer unit 20B is configured to include an endless belt 20B1, which is formed by each single color unit 20, and which revolves in a state of holding the toner images G of each color, which are primarily transferred, on the outer periphery thereof.

Transport Device

The transport device 30 has a function of transporting the medium P so that the medium P passes through the nip N1 and a nip N2 (refer to FIG. 1), which will be described below.

Fixing Device

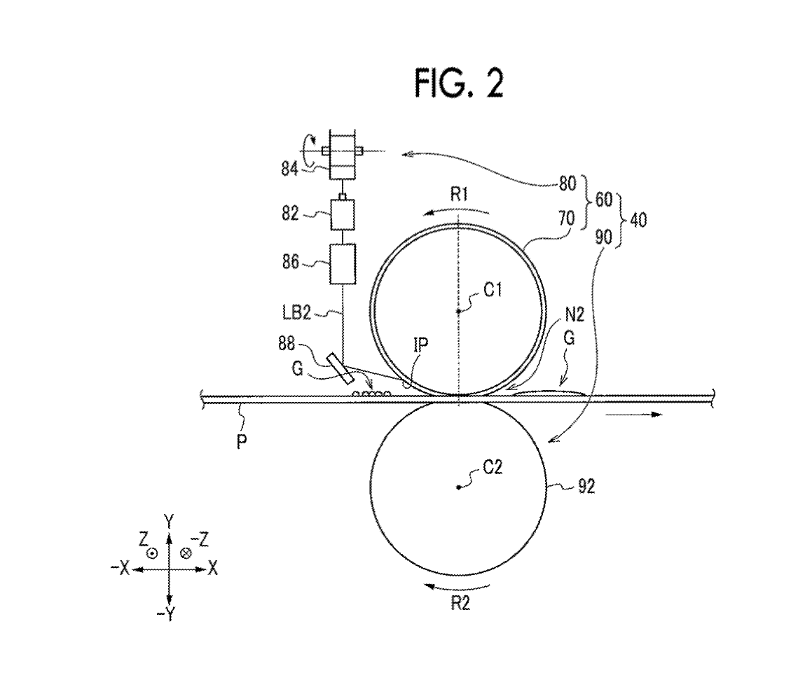

The fixing device 40 has a function of fixing the toner images G to the medium P by heating and pressurizing the toner images G that are formed on the medium P by the toner image formation section 20. As shown in FIG. 2, the fixing device 40 is configured to include a heating section 60 and a pressurization section 90.

Heating Section

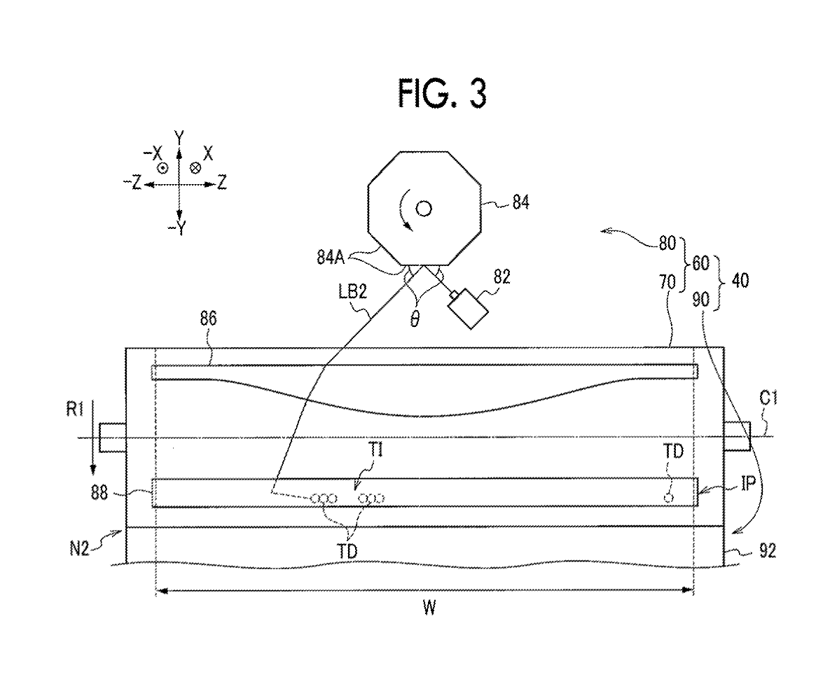

The heating section 60 has a function of heating the toner T that configures the toner images G, which are formed on the medium P by the toner image formation section 20 (hereinafter, referred to as the toner T). As shown in FIGS. 2 and 3, the heating section 60 is configured to include a heating belt 70, an irradiation device 80, a cap (not shown in the drawings), and a gear (not shown in the drawings). In this instance, the toner T is an example of particles that configure images that are formed on the medium. The heating belt 70 is an example of a heating body. In addition, the heating section 60 is an example of a heating device. Additionally, heating the toner T does not merely refer to applying heat to the toner T, but refers to applying a required amount of heat to the toner T in order to fix the toner images G to the medium P. Further, in order to fix the toner T, the temperature of the heating belt 70 is set to approximately 180° C. (a fixing temperature T), as an example, at a position that comes into contact with the toner images G at the nip N2.

Heating Belt

As shown in FIG. 2, the heating belt 70 has a function of heating the toner T on the medium P, which comes into contact with an outer periphery of the heating belt 70 that forms the nip N2, by interposing the medium P, which is transported to the nip N2 that the heating belt 70 forms with a pressurization roller 92, which will be described below. The heating belt 70 is set to be tubular, and is disposed in a state in which a self axis thereof runs along the device depth direction. In addition, the cap (not shown in the drawings) is inserted at an end section of a front side in the device depth direction of the heating belt 70, and the gear (not shown in the drawings) is fitted to an end section of a deep side in the device depth direction. Further, the heating belt 70 runs along a predetermined pathway to follow rotation of the gear about a self axis thereof as a result of a drive source (not shown in the drawings). Additionally, a point C1 in the drawings shows the self axis of the heating belt 70.

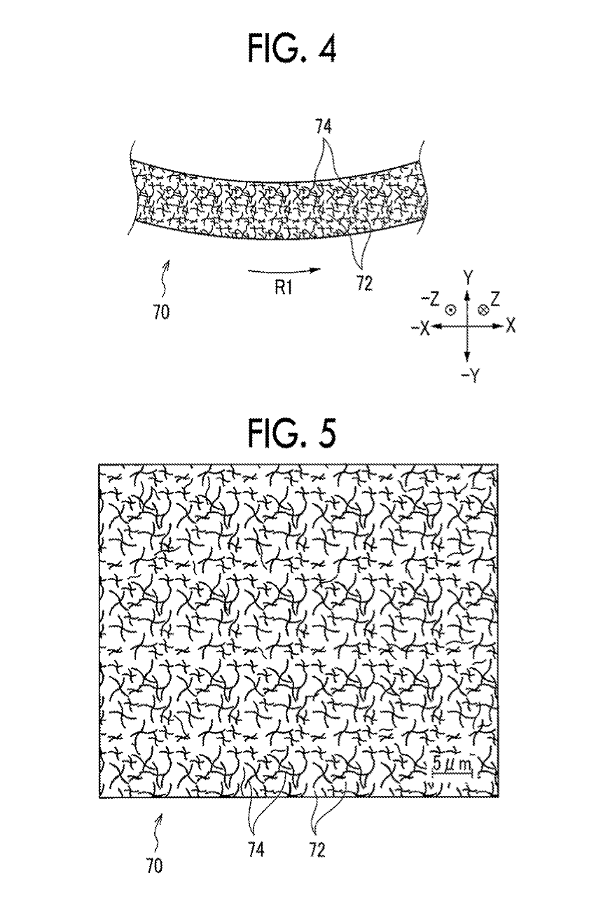

As shown in FIGS. 4 and 5, the heating belt 70 is configured to include a binder 72 and carbon nanotubes 74 (hereinafter, referred to as CNTs 74). The binder 72 supports the CNTs 74, which are dispersed in a fixed region of the heating belt 70. The CNTs 74 being dispersed in a fixed region of the heating belt 70 refers to being randomly disposed in all directions of a thickness direction, a circumferential direction, and a width direction in a region in which the heating belt 70 heats the toner T. In addition, a region in which the heating belt 70 fixes the toner T is set as a region that is inside a range W in FIG. 3. In this instance, the binder 72 is an example of a support body. The binder 72 is set to be transparent, and irradiation light LB2 that is irradiated by the irradiation device 80, which will be described below, and that enters the heating belt 70 is transmitted therethrough. In this instance, transmission refers to the irradiation light LB2 that has penetrated into the heating belt 70 progressing to an internal section of the binder 72. The binder 72 according to the present exemplary embodiment is configured by a polyimide, as an example.

The CNTs 74 absorb the irradiation light LB2, which the binder 72 transmits, and generate heat. In this instance, the CNTs 74 is an example of a heat-emitting body.

Additionally, in the present exemplary embodiment, a ratio (a weight ratio) of the binder 72 and the CNTs 74, which configure the heating belt 70, is set to 2:1, as an example.

Irradiation Device

The irradiation device 80 has a function of selectively irradiating a portion of the heating belt 70 that the toner T on the medium P comes into contact with, with the irradiation light LB2. In this instance, the irradiation light LB2 is an example of light. In addition, the irradiation device 80 is an example of an irradiation section. As shown in FIGS. 2 and 3, the irradiation device 80 is provided with a light source 82, a polygon mirror 84, an fθ lens 86, and a reflective mirror 88. Additionally, as shown in FIG. 2, the irradiation device 80 is disposed on an upstream side in a transport direction of the medium P with respect to the heating belt 70 when viewed from a front side in the device depth direction. In addition, the constituent elements which configure the irradiation device 80 are disposed in the device height direction in the order of the polygon mirror 84, the light source 82, the fθ lens 86 and the reflective mirror 88 from an upper side in the device height direction.

The light source 82 irradiates irradiation light LB2 toward the polygon mirror 84. The polygon mirror 84 reflects the irradiation light LB2 that the light source 82 irradiates while rotating about a self axis. The fθ lens 86 refracts the irradiation light LB2 so that the irradiation light LB2, reflected by the polygon mirror 84, is scanned by the heating belt 70 at a uniform speed. The reflective mirror 88 reflects the irradiation light LB2 so that the irradiation light LB2, transmitted through the fθ lens 36, enters the heating belt 70. Additionally, the irradiation device 80 irradiates a portion in the heating belt 70 which is further on an upstream side in a rotational direction of the heating belt 70 than the nip N2, and which is further on a lower side in the device height direction than the self axis of the heating belt 70 set as an irradiation position IP of the irradiation light LB2 with the irradiation light LB2. In this instance, the portion that is on the upstream side in the rotational direction of the heating belt 70 refers to a portion that is further on the upstream side in the transport direction of the medium P than a virtual straight line (a dotted line in the drawing) in the heating belt 70 that connects a center of the nip N2 and the point C1 when viewed from the front side in the device depth direction.

Further, the irradiation device 80 forms a thermal image TI by selectively irradiating the heating belt 70 with the irradiation light LB2 while scanning the irradiation light LB2 in the self axis direction of the heating belt 70, which rotates about the self axis thereof, based on irradiation data, which will be described below. In this instance, in the same manner as a latent image, the thermal image TI refers to an image which is not visible for the human eye, and which is a thermal energy image that is formed by the heating belt 70 being irradiated with the irradiation light LB2. In addition, the irradiation device 80 is configured so as to be capable of irradiating an irradiation dot TD with a diameter D2 (corresponds to approximately 25 μm) in a −Z direction and a rotational direction (respectively correspond to a main scanning direction and a sub-scanning direction of the irradiation light LB2) of the self axis of the heating belt 70 (refer to FIG. 6). In addition, the diameter D2 of the irradiation dot TD, which the irradiation device 80 irradiates, is larger than the diameter D1 of the exposure dots LD, which the exposure device 26 exposes.

Pressurization Section

The pressurization section 90 has a function of forming the nip N2 with the heating belt 70, and a function of pressurizing the medium P, which is transported by the transport device 30 and passes through the nip N2, with the heating belt 70. As shown in FIGS. 2 and 3, the pressurization section 90 is provided with the pressurization roller 92 and a gear (not shown in the drawings). The gear (not shown in the drawings) is fitted to an end section of a deep side of the pressurization roller 92 in the device depth direction. Further, the pressurization roller 92 is rotated about a self axis thereof (in a direction of an arrow R2 in the drawing) to follow rotation of the gear (not shown in the drawings) about a self axis thereof as a result of a drive source (not shown in the drawings). Additionally, a point C2 in the drawings shows the self axis of the pressurization roller 92.

Control Section

The control section 50 has a function of controlling each section other than the control section 50 that configures the image formation apparatus 10.

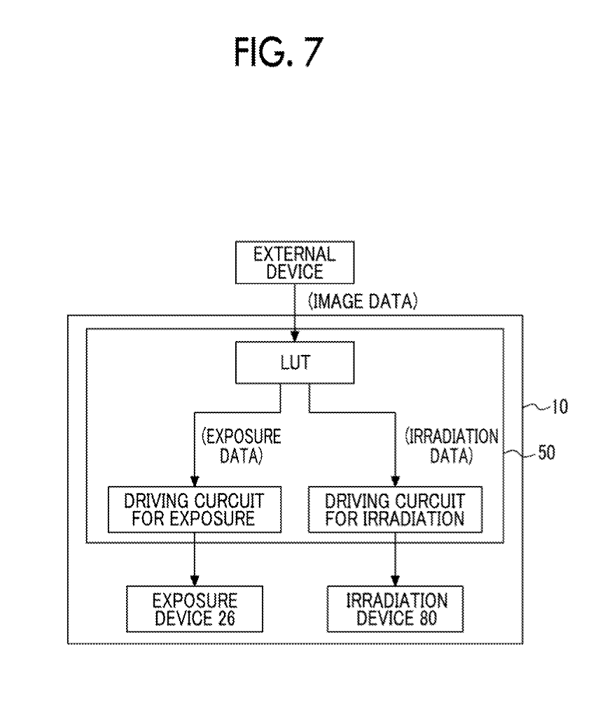

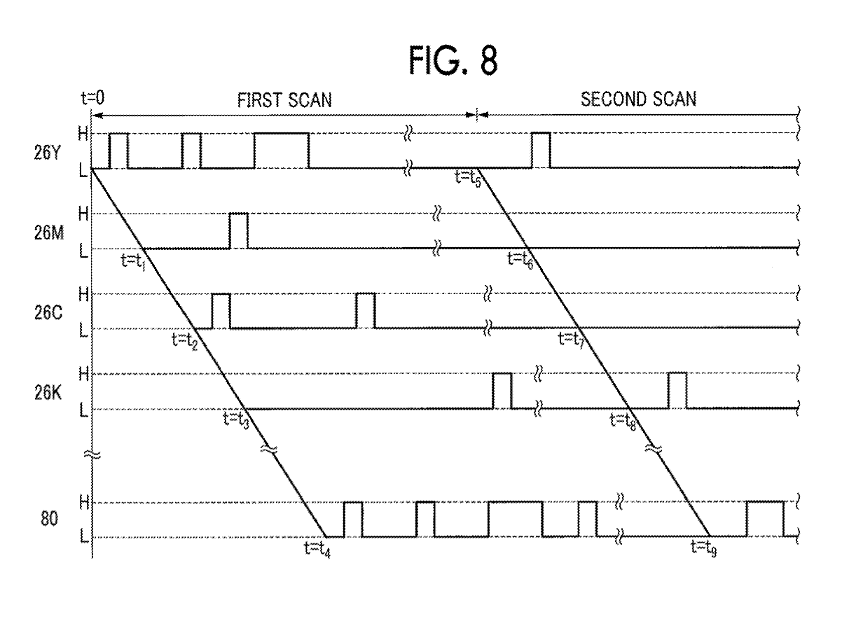

As shown in FIG. 7, as an example, the control section 50 receives image data from an external device, and converts the image data into exposure data and irradiation data using a Lookup Table (LUT) of a storage device (not shown in the drawings), which the control section 50 is provided with. Further, when the control section 50 drives a driving circuit for exposure, which the control section 50 is provided with, based on the exposure data of each color, as shown in FIG. 8, each exposure device 26 forms each latent image by selectively exposing each photosensitive drum 22 with each exposure light LB1. In addition, when the control section 50 drives a driving circuit for irradiation, which the control section 50 is provided with, based on the irradiation data, as shown in FIG. 8, the irradiation device 80 forms a thermal image TI on the heating belt 70 by selectively irradiating the heating belt 70 with the irradiation light LB2. At this time, the control section 50 causes the irradiation device 80 to irradiate the irradiation light LB2 so that the thermal image TI overlaps with the toner images G on the medium P, which is transported, at the nip N2, that is, so as to match a timing with which the toner images G pass through the nip N2.

Supplement

The irradiation device 80 forms the thermal image TI on the heating belt 70 so that the irradiation dot TD comes into contact with the toner T and portions of the medium P that are in the vicinity of the toner T at the nip N2. At this time, the irradiation device 80 forms the irradiation dot TD so that a center O of the toner T, which is formed by the exposure dots LD and center O of the irradiation dot TD, which comes into contact with the toner T coincide at the nip N2.

The configuration of the image formation apparatus 10 according to the present exemplary embodiment has been described above.

Actions of Image Formation Apparatus

The operations of the image formation apparatus 10 according to the present exemplary embodiment will be described with reference to the drawings.

The control section 50, in which image data is received from an external device, activates the photosensitive body unit 20A and the transfer unit 20B, which configure the toner image formation section 20, the transport device 30, and the fixing device 40.

As shown in FIG. 7, the control section 50 converts the image data into exposure data (exposure data of each color) and irradiation data using the Lookup Table (LUT). Further, when the control section 50 drives the driving circuit for exposure based on the exposure data of each color, each exposure device 26 forms latent images by exposing each photosensitive drum 22, which is charged by the charging device 24 (refer to FIG. 8). Subsequently, in the photosensitive drum 22, each toner image G is formed as a result of each latent image being developed by the developing device 28. Next, each toner image G, which is developed on each photosensitive drum 22, is primarily transferred to the endless belt 20B1, which revolves, and is further secondary transferred onto the medium P, which is transported by the transport device 30, at the nip N1. In the above-mentioned manner, a toner image G in which toner images G of each color are superimposed upon one another, is formed on the medium P by the toner image formation section 20. Subsequently, the medium P, on which the superimposed toner image G is formed, is transported toward the fixing device 40 by the transport device 30 (refer to FIG. 1).

Next, the control section 50 drives the driving circuit for irradiation based on the irradiation data. Following this, the irradiation device 80, which configures the fixing device 40, forms a thermal image TI on the heating belt 70 by selectively irradiating the heating belt 70 with the irradiation light LB2 to match a timing with which the toner images G on the medium P pass through the nip N2 (refer to FIG. 8). Further, the toner T on the medium P, which passes through the nip N2, comes into contact with a portion (the irradiation dot TD) of the heating belt 70 that is irradiated with the irradiation light LB2, is heated, and is pressurized by the heating belt 70 and the pressurization roller 92 when passing through the nip N2. Accordingly, the toner T on the medium P, which passes through the nip N2, is fixed to the medium P. Further, the medium P, on which the toner T is fixed, is discharged outside the image formation apparatus 10, and the operations of the image formation apparatus 10 are completed.

The operations of the image formation apparatus 10 have been described above.

Actions

Next, actions according to the present exemplary embodiment will be described with reference to the drawings.

First Action

In this instance, a first action according to the present exemplary embodiment will be described in comparison with a first comparative embodiment that is assumed below.

A fixing device according to the first comparative embodiment is a fixing device of a method in which a heating belt (not shown in the drawings) is caused to emit heat using electromagnetic induction, a so-called IH fixing device. Therefore, the heating belt of the fixing device according to the first comparative embodiment is a metal belt. Further, the image forming apparatus (not shown in the drawings) according to the first comparative embodiment is a DocuPrint (Registered Trademark) C4000d (manufactured by Fuji Xerox Co., Ltd.).

In the case according to the first comparative embodiment, approximately 1,000 W of power is necessary for approximately 3 s in order to raise the temperature of the heating belt to the fixing temperature T.

In contrast to this, as shown in FIGS. 4 and 5, the heating belt 70 according to the present exemplary embodiment is configured to include the CNTs 74, which absorb the irradiation light LB2 that passes through the binder 72 and emit heat. In addition, when the heating belt 70 according to the present exemplary embodiment is irradiated with the irradiation light LB2, the irradiated portion emits heat. Further, in the case of the heating belt 70 according to the present exemplary embodiment, in order to increase the temperature of the heating belt 70 to the fixing temperature T, it is sufficient to irradiate the heating belt 70 with the irradiation light LB2 for approximately 30 ms, which corresponds to 200 W to 500 W of power.

Therefore, the temperature of the heating belt 70 according to the present exemplary embodiment increases to the fixing temperature T with little energy in comparison with the heating belt according to the first comparative embodiment. That is, the heating belt 70 and the heating section 60 according to the present exemplary embodiment are capable of heating the toner T with little energy in comparison with the heating belt according to the first comparative embodiment. In addition, in the heating section 60 and the fixing device 40 according to the present exemplary embodiment, a time from starting the supply of energy until the heating of the toner T on the medium P is possible is short in comparison with the heating section and the fixing device according to the first comparative embodiment. In accordance with this, in the image formation apparatus 10 according to the present exemplary embodiment, image formation is possible at high speed in comparison with the image forming apparatus according to the first comparative embodiment.

Second Action

Next, a second action according to the present exemplary embodiment will be described in comparison with a second comparative embodiment that is assumed below.

The irradiation device 80 that configures the heating section 60 according to the second comparative embodiment irradiates a portion that corresponds to the entire width of the medium P with a width that corresponds to the irradiation light LB2 at the irradiation position IP. That is, the irradiation device 80 according to the second comparative embodiment does not selectively irradiate based on the irradiation data, which is converted from the image data with the irradiation light LB2, in the same manner as that of the irradiation device 80 according to the present exemplary embodiment. Other than a control method of the irradiation device 80 being as described above, the configurations of the heating section 60, the fixing device 40, and the image formation apparatus 10 according to the second comparative embodiment are set to be the same configurations as that of the heating section 60, the fixing device 40, and the image formation apparatus 10 according to the present exemplary embodiment. Additionally, the heating section 60, the fixing device 40, and the image formation apparatus 10 according to the second comparative embodiment belong to the technical range according to the exemplary embodiment of the invention.

In the above-mentioned manner, the irradiation device 80 according to the second comparative embodiment irradiates a portion that corresponds to the entire width of the medium P with the irradiation light LB2 at the irradiation position IP regardless of a formation rate (a percentage of area in which the toner images G are formed with respect to a unit area of the medium P) of the toner images G on the medium P. Therefore, the irradiation device 80 according to the second comparative embodiment continues to irradiate a portion that corresponds to the entire width of the medium P with the irradiation light LB2 at the irradiation position IP for a period that corresponds to a period during which the medium P passes through the nip N2.

In contrast to this, as shown in FIG. 3, the irradiation device 80 according to the present exemplary embodiment forms the thermal image TI (refer to FIG. 3) by selectively irradiating the heating belt 70 with the irradiation light LB2 while scanning the heating belt 70 with the irradiation light LB2 in the self axis direction based on the irradiation data. Therefore, in the irradiation device 80 according to the present exemplary embodiment, a lighting time of the irradiation light LB2 fluctuates depending on a formation rate of the toner image G on the medium P.

Therefore, according to the irradiation device 80 (the heating section 60) according to the present exemplary embodiment, it is possible to suppress the energy that is consumed to an amount of energy required in order to heat the toner T. In other words, according to the irradiation device 80 (the heating section 60) according to the present exemplary embodiment, the energy that is consumed is suppressed in comparison with the irradiation device 80 (the heating section 60) according to the second comparative embodiment. In accordance with this, according to the fixing device 40 and the image formation apparatus 10 according to the present exemplary embodiment, the energy that is consumed is suppressed in comparison with the fixing device 40 and the image formation apparatus 10 according to the second comparative embodiment.

Third Action

Next, a third action according to the present exemplary embodiment will be described in comparison with a third comparative embodiment that is assumed below.

The irradiation device 80 that configures the heating section 60 according to the third comparative embodiment forms the same thermal image TI as the toner image G on the heating belt 70, when the thermal image TI is formed by selectively irradiating the heating belt 70 with the irradiation light LB2 based on the irradiation data. Other than the size of the thermal image TI which is formed by the irradiation device 80 as described above, the configurations of the heating section 60, the fixing device 40, and the image formation apparatus 10 according to the third comparative embodiment are set to be the same configurations as that of the heating section 60, the fixing device 40, and the image formation apparatus 10 according to the present exemplary embodiment. Additionally, the heating section 60, the fixing device 40, and the image formation apparatus 10 according to the third comparative embodiment belong to the technical range of the exemplary embodiment of the present invention.

In the above-mentioned manner, the irradiation device 80 according to the third comparative embodiment forms the same thermal image TI as the toner image G. Therefore, when the medium P, which passes through the nip N2, is transported in the transport direction of the medium P or in the self axis direction of the heating belt 70 in a state of being shifted positionally or in a timing manner, there is a concern that the irradiation dot TD will not come into contact with a portion of or with the entirety of the toner T. Further, in a case in which the irradiation dot TD does not come into contact with a portion of or with the entirety of the toner T, the toner images are fixed to the medium P in a state in which a portion of or the entirety of the toner T is not heated (hereinafter, referred to as a first problem). In addition, even if the medium P, which passes through the nip N2, is transported in the transport direction of the medium P or in the self axis direction of the heating belt 70 without being shifted positionally or in a timing manner, a temperature difference is generated between outer peripheral portions of the toner T and the medium P on the outer sides thereof. Therefore, the adhesiveness of the toner T to the medium P in outer peripheral portions is lower than the adhesiveness of the toner T to the medium P in inner side portions, and there is a concern that the toner T of outer peripheral portions will be defective (hereinafter, referred to as a second problem).

In contrast to this, the irradiation device 80 according to the present exemplary embodiment forms the thermal image TI on the heating belt 70 so that the irradiation dot TD comes into contact with the toner T and portions of the medium P that are in the vicinity of the outer periphery of the toner T at the nip N2. Therefore, in the case according to the present exemplary embodiment, in comparison with the third comparative embodiment, even if the medium P, which passes through the nip N2, is transported in the transport direction of the medium P or in the self axis direction of the heating belt 70 in a state of being shifted positionally or in a timing manner, there is a tendency for the irradiation dot TD to come into contact with the toner T. In addition, in the case according to the present exemplary embodiment, in comparison with the third comparative embodiment, when the medium P, which passes through the nip N2, is transported in the transport direction of the medium P or in the self axis direction of the heating belt 70 without being shifted positionally or in a timing manner, it is difficult to generate a temperature difference in outer peripheral portions of the toner T and the medium P on the outer sides thereof.

Therefore, in comparison with the heating section 60 according to the third comparative embodiment, it is unlikely that the first problem will occur in the heating section 60 according to the present exemplary embodiment. In addition, in comparison with the heating section 60 according to the third comparative embodiment, it is unlikely that the second problem will occur in the heating section 60 according to the present exemplary embodiment. That is, the adhesiveness of the toner T to the medium P of outer peripheral portions in the heating section 60 according to the present exemplary embodiment is higher than the heating section 60 according to the third comparative embodiment.

### Modification Examples According to First Exemplary Embodiment

Next, modification examples (first and second modification examples) according to the present exemplary embodiment will be described with reference to the drawings.

### First Modification Example

### Configuration

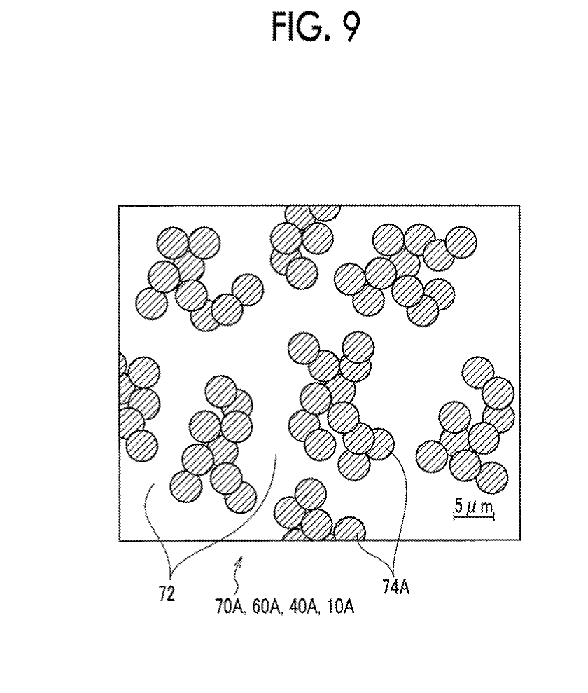

As shown in FIG. 9, a heating belt 70A according to the first modification example includes carbon black 74A (hereinafter, referred to as a CB 74A) in place of the CNTs 74 according to the present exemplary embodiment. In this instance, the CB 74A is an example of a heat-emitting body. In addition, the heating belt 70A is an example of a heating body. Other than the above-mentioned point, the configuration of the heating belt 70A according to the first modification example is the same as that of the heating belt. 70 according to the present exemplary embodiment. That is, the ratio (the weight ratio) of the binder 72 and the CB 74A is set as 2:1 in the same manner as the heating belt 70 according to the present exemplary embodiment. In addition, other than being provided with the heating belt 70A according to the first modification example, a heating section 60A, a fixing device 40A, and an image formation apparatus 10A according to the first modification example are respectively set to the same configurations as that of the heating section 60, the fixing device 40, and the image formation apparatus 10 according to the present exemplary embodiment. In this instance, the heating section 60A according to the first modification example is an example of a heating device.

Actions

The actions according to the first modification example are the same as the actions according to the first exemplary embodiment.

Supplement

As shown in FIG. 9, in the heating belt 70A according to the first modification example, the CB 74A of the heating belt 70A is dispersed in an aggregated state. In contrast to this, in the heating belt 70 according to the present exemplary embodiment (refer to FIG. 5), the heat-emitting body (the CNTs 74) is dispersed in a finely spread out state in comparison with the heating belt 70A according to the first modification example (refer to FIG. 9).

Therefore, according to the heating belt 70 according to the present exemplary embodiment, in comparison with the heating belt 70A according to the first modification example, it is unlikely that heat generation spots (temperature spots) will occur inside portions onto which the irradiation light LB2 is irradiated when the irradiation position IP is irradiated with the irradiation light LB2 and the heating belt 70 comes into contact with the toner T at the nip N2. In accordance with this, in comparison with the heating section 60A according to the first modification example, it is unlikely that heating spots will occur in the toner image G on the medium P in the heating section 60 according to the present exemplary embodiment. In addition, in comparison with the fixing device 40A according to the first modification example, fixing defects that result from heating spots are suppressed in the fixing device 40 according to the present exemplary embodiment. In addition, in comparison with the image formation apparatus 10A according to the first modification example, image formation defects that result from fixing defects are suppressed in the image formation apparatus 10 according to the present exemplary embodiment.

In addition, the absorbency of the irradiation light LB2 in the CNTs 74, which are included in the heating belt 70 according to the present exemplary embodiment, is higher than that in the CB 74A, which is included in the heating belt 70A according to the first modification example. Therefore, in comparison with the CB 74A according to the first modification example, there is a tendency for the irradiation light LB2 to be absorbed and for heat to be emitted in the CNTs 74 according to the present exemplary embodiment.

Therefore, according to the heating belt 70 according to the present exemplary embodiment, it is possible to heat the toner T with less energy than that of the heating belt 70A according to the first modification example.

In addition, as shown in FIG. 2, in the heating section 60 and the fixing device 40 according to the present exemplary embodiment, the heating belt 70 forms the nip N2 with the pressurization roller 92 and pressurizes the medium P while rotating about the self axis thereof. Therefore, it is necessary that the heating belt 70 be durable in a usage environment of being pressurized while rotating. Further, in comparison with the heating belt 70A according to the first modification example, the flexibility of the heating belt 70 according to the present exemplary embodiment is high due to the shape of the heat-emitting body. In addition, in comparison with the heat-emitting body (the CB 74A) according to the first modification example, it is unlikely that the heat-emitting body (the CNTs 74) according to the present exemplary embodiment will fall away from the binder 72.

Therefore, according to the heating belt 70 according to the present exemplary embodiment, the life span is long in comparison with the heating belt 70A according to the first modification example.

### Second Modification Example

### Configuration

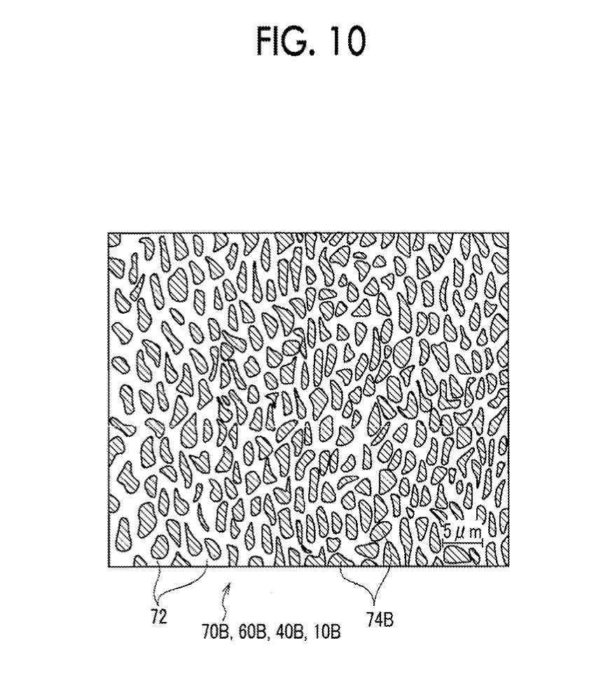

As shown in FIG. 10, a heating belt 70B according to the second modification example includes a graphene film 74B in place of the CNTs 74 according to the present exemplary embodiment. In this instance, the graphene film 74B is an example of a heat-emitting body. In addition, the heating belt 70B is an example of a heating body. Other than the above-mentioned point, the configuration of the heating belt 70B according to the second modification example is the same as that of the heating belt 70 according to the present exemplary embodiment. That is, the ratio (the weight ratio) of the binder 72 and the graphene film 74B is set to 2:1 in the same manner as the heating belt 70 according to the present exemplary embodiment. In addition, other than the feature of being provided with the heating belt 70B according to the second modification example, a heating section 60B, a fixing device 40B, and an image formation apparatus 10B according to the second modification example are respectively set to the same configurations as that of the heating section 60, the fixing device 40, and the image formation apparatus 10 according to the present exemplary embodiment. In this instance, the heating section 60B according to the second modification example is an example of a heating device.

Actions

The actions according to the second modification example are the same as the actions according to the first exemplary embodiment and the first modification example.

Supplement

Since the thermal conductivity of the graphene film 74B is higher than that of the CNTs 74, the thermal conductivity of the heating belt. 70 according to the present exemplary embodiment is lower than that of the heating belt 70B according to the second modification example. Therefore, in comparison with the heating belt 70B according to the second modification example, it is unlikely that the heat of each irradiation dot TD will scatter in the heating belt 70 according to the present exemplary embodiment. In addition, a contact area of contact surfaces between particles of graphene that configure the graphene film 74B is smaller than a contact area of contact surfaces between CNTs 74. Therefore, in comparison with the heating belt 70B according to the second modification example, it is unlikely that the heat of each irradiation dot TD will be scattered in the heating belt 70 according to the present exemplary embodiment.

Therefore, in the heating belt 70 according to the present exemplary embodiment, in comparison with the heating belt 70B according to the second modification example, it is unlikely that the temperature of the irradiation dots TD which come into contact with the toner T at the nip N2 will fall. Therefore, in the heating section 60 according to the present exemplary embodiment, in comparison with the heating section 60B according to the second modification example, it is possible to set the energy of the irradiation light LB2 that is radiated by the irradiation dot TD to be lower. In addition, in comparison with the fixing device 40B according to the second modification example, fixing defects that result from energy shortages are suppressed in the fixing device 40 according to the present exemplary embodiment. In addition, in comparison with the image formation apparatus 10B according to the second modification example, image formation defects that result from fixing defects are suppressed in the image formation apparatus 10 according to the present exemplary embodiment.

### Second Exemplary Embodiment

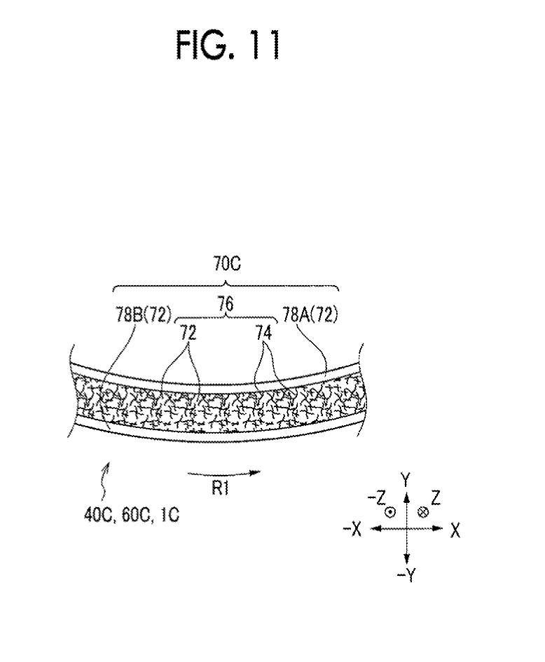

Next, the second exemplary embodiment will be described with reference to FIG. 11.

Configuration

A heating belt 70C according to the present exemplary embodiment is configured to include a heat emission layer 76, which is formed in a tubular shape, an inner peripheral layer 78A, which is provided on an inner peripheral surface of the heat emission layer 76, and an outer peripheral layer 78B, which is provided on an outer peripheral surface of the heat emission layer 76. The heat emission layer 76 is configured in the same manner as the heating belt 70 according to the first exemplary embodiment. Both the inner peripheral layer 78A and the outer peripheral layer 788B are configured by the binder 72. Additionally, as a result of the inner peripheral layer 78A and the outer peripheral layer 78B being provided in the heating belt 70C, the rigidity thereof is greater than the heating belt 70. In addition, the inner peripheral layer 78A and the outer peripheral layer 78B have a function of supporting the CNTs 74, which are included in the heat emission layer 76. In this instance, the binder 72 that is included in the heat emission layer 76, the binder 72 of the inner peripheral layer 78A, and the binder 72 of the outer peripheral layer 78B are examples of support bodies. Other than the above-mentioned points, the configurations of the heating section 60C, the fixing device 40C, and the image formation apparatus 10C according to the present exemplary embodiment are set to be the same as those of the heating section 60, the fixing device 40, and the image formation apparatus 10 according to the first exemplary embodiment. In this instance, the heating section 60C is an example of a heating device.

Actions

The actions according to the present exemplary embodiment are the same as the actions according to the first exemplary embodiment and the modification examples thereof.

### Third Exemplary Embodiment

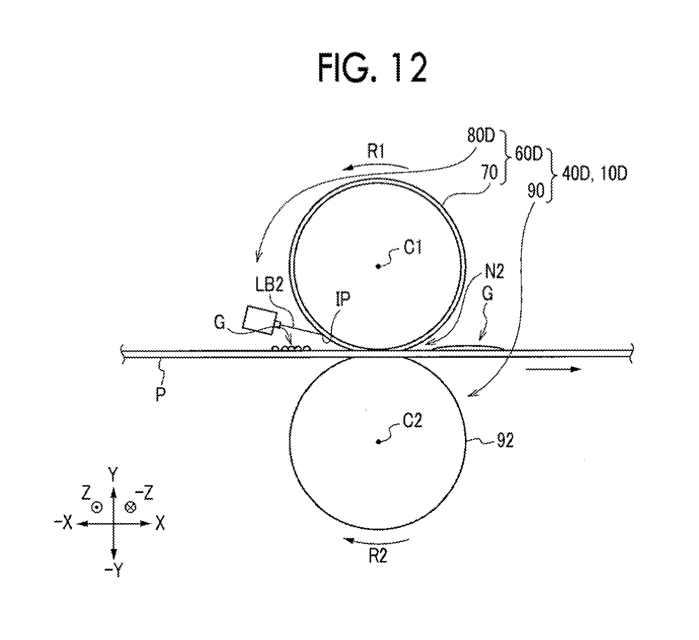

Next, the third exemplary embodiment will be described with reference to FIG. 12.

Configuration

An irradiation device 80D according to the present exemplary embodiment is an LED head type device in place of the irradiation device 80 according to the first exemplary embodiment. The irradiation device 80D is set to be longitudinal, and includes multiple light sources (not shown in the drawings) that are lined up in a longitudinal direction thereof. Further, the irradiation device 80D is disposed in a state in which the longitudinal direction thereof runs along the self axis direction of the heating belt 70. Therefore, the irradiation device 80D according to the present exemplary embodiment differs from the irradiation device 80 according to the first exemplary embodiment, and irradiates the heating belt 70 with the irradiation light LB2 at the irradiation position IP by causing the light source to emit light to correspond to irradiation data. Other than the points mentioned above, the configurations of a heating section COD, a fixing device 40D, and an image formation apparatus 100 are set to be the same as those of the heating section 60, the fixing device 40, and the image formation apparatus 10 according to the first exemplary embodiment. In this instance, the heating section 60D is an example of a heating device. In addition, the irradiation device 80D is an example of an irradiation section.

Actions

In comparison with the irradiation device 380 according to the first exemplary embodiment, it is possible to dispose the irradiation device 30D according to the present exemplary embodiment in a narrower portion in the device height direction. Other actions according to the present exemplary embodiment are the same as the actions according to the above-mentioned exemplary embodiments (including the modification examples according to the first exemplary embodiment).

### Fourth Exemplary Embodiment

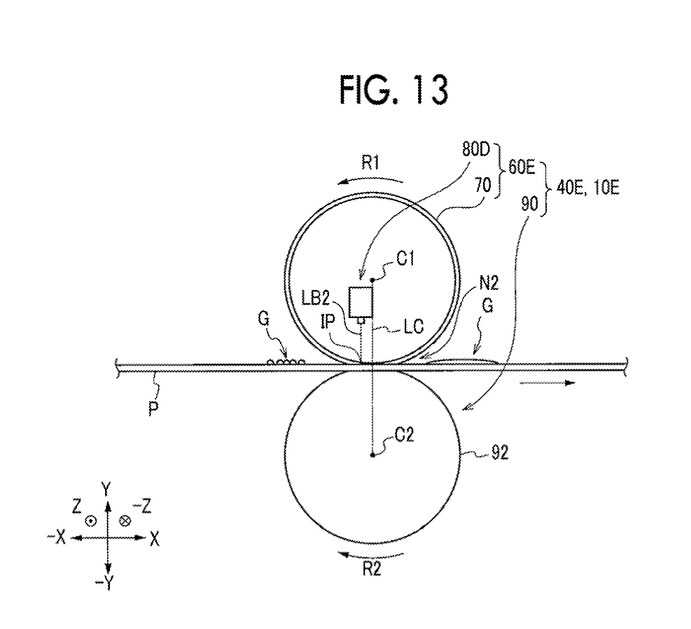

Next, the fourth exemplary embodiment will be described with reference to FIG. 13.

Configuration

The irradiation device 80D according to the present exemplary embodiment differs from the irradiation device 80D according to the third exemplary embodiment, and is disposed inside the heating belt 70. Therefore, the irradiation device 80D according to the present exemplary embodiment differs from the irradiation device 80D according to the third exemplary embodiment, and irradiates the inner periphery of the heating belt 70 with the irradiation light LB2. In addition, the irradiation device 80D according to the present exemplary embodiment irradiates a portion in the heating belt 70 at which the nip N2 is formed with the irradiation light LB2, and which is further on an upstream side in a rotational direction of the heating belt 70 than the centre of the nip N2 when viewed from the device depth direction. In this instance, the center of the nip N2 refers to a portion of the nip N2 in the drawing through which a virtual straight line (a dashed-dotted chain line in the drawing) passes that connects the point C1 and a point C2. Other than the points mentioned above, the configurations of a heating section 60E, a fixing device 40E, and an image formation apparatus 10E according to the present exemplary embodiment are set to be the same as those of the heating section 60D, the fixing device 40D, and the image formation apparatus 10D according to the third exemplary embodiment. In this instance, the heating section 60E is an example of a heating device.

Actions

In the above-mentioned manner, the irradiation device 80D according to the present exemplary embodiment is disposed inside the heating belt 70. Therefore, the heating section 60E and the fixing device 40E according to the present exemplary embodiment may be reduced in size in comparison with the heating section 60D and the fixing device 40D according to the third exemplary embodiment.

In addition, in comparison with the heating sections 60, 60C, and 60D, and the fixing devices 40, 40C, and 40D according to the first to third exemplary embodiments, the degree of freedom of the heating section 60E and the fixing device 40E according to the present exemplary embodiment that sets the irradiation position IP at which the irradiation light LB2 is radiated, is high. Therefore, the case according to the present exemplary embodiment differs from the above-mentioned exemplary embodiments (including the modification examples according to the first exemplary embodiment), and it is possible to set the irradiation position IP to a portion of the heating belt 70 in which the nip N2 is formed. That is, in the present exemplary embodiment, different from the above-mentioned exemplary embodiments, it is possible to reduce the energy of the irradiation light LB2 as a result of the fact that it is possible to bring the irradiation position IP and a pressurization position of the toner T on the medium P closer together, or to align the positions. Other actions according to the present exemplary embodiment are the same as the actions of that according to the above-mentioned exemplary embodiments.

Specific exemplary embodiments of the present invention have been described in detail above, but the present invention is not limited to the above-mentioned exemplary embodiments, and other exemplary embodiments are possible within the range of the technical idea of the present invention.

For example, the image formation apparatuses 10, 10C, 10D, and 10D according to each exemplary embodiment (including the modification examples) are described as electrophotographic type apparatuses. However, as long as the image forming apparatuses that are provided with the heating sections 60, 60C, 60D, and 60E are image forming apparatuses in which the heating sections 60, 60C, 60D, and 60E heat particles that configure images on the medium P, the image forming apparatuses need not be electrophotographic type apparatuses. For example, the image forming apparatuses which are provided with the heating sections 60, 60C, 60D, and 60E may be ink jet type apparatuses, flexographic type printing apparatuses, or another type of image forming apparatus. Additionally, in a case of an ink jet type image forming apparatus, the elements that form images by discharging liquid droplets (as an example of an ink) onto the medium P using an ink jet head are examples of formation sections. In addition, the liquid droplets are an example of particles that configure an image on the medium. In addition, in a case of a flexographic printing type image forming apparatus, the elements that form images, which are configured by ink, on the medium P using a printing plate are an example of formation sections. In addition, ink is an example of particles that configure an image on the medium.

In addition, in the descriptions of the heating belt 70 in the first exemplary embodiment and the heat emission layer 76 of the heating belt 70C in the second exemplary embodiment, the CNTs 74, which is a heating body, is randomly disposed in all directions of a thickness direction, a circumferential direction, and a width direction of the heating belt 70. However, a configuration, in which the density of the CNTs 74 of both end sides of the heating belt 70 or the heat emission layer 76 in the self axis direction thereof is higher than portions other than both end sides in the self axis direction thereof, may be adopted. As a result of this, in a case of the irradiation device 80, which irradiates while scanning the heating belt 70 with the irradiation light LB2 in an axial direction, temperature differences between the fixing temperature T of both end sides of the heating belt 70 and the fixing temperature T of portions other than both end sides in the self axis direction are relieved.

In addition, in the first and second exemplary embodiments, the heating belt 70 emitting heat using the irradiation device 80, which irradiates the irradiation light LB2 in a self axis direction of the heating belt 70, is described. In this case, the irradiation light LB2 that is input close to the end sections of the heating belt 70 in the self axis direction tends to be input in a wide state in comparison with the irradiation light LB2 that is input to the center of the self axis direction of the heating belt 70. However, a configuration, in which the output of the light source 82 may be adjusted and the intensity of the irradiation light LB2 that is input close to the end sections of the heating belt 70 in the self axis direction is higher than the intensity of the irradiation light LB2 that is input to the center of the self axis direction of the heating belt 70, may be adopted. Accordingly, temperature differences between the fixing temperature T of both end sides of the heating belt 70 and the fixing temperature T of portions other than both end sides in the self axis direction are relieved.

In addition, in each exemplary embodiment (including the modification examples), the heating belts 70 and 70C, that is, belts, are described as an example of a heating body. However, as long as the heating body includes a support body that supports a heat-emitting body, and the heat-emitting body, and the heat-emitting body absorbs the irradiation light LB2 that the support body transmits, the example of the heating body need not be a belt. For example, the heating body may be a drum.

In addition, as long as the pressurization roller 92 has a function of forming the nip N2 with the heating belt 70, a separate heating unit (a heater (not shown in the drawings) as one example) may be provided inside the pressurization roller 92, and the pressurization roller 92 may be made to have a function of heating the toner image G on the medium P.

In addition, in the irradiation devices 80 and 80B according to the first and second exemplary embodiments, one fθ lens 86 (refer to FIGS. 2 and 3) is described. However, in the irradiation devices 80 and 80B, multiple fθ lenses may be provided.

In addition, the heating belt 70C according to the second exemplary embodiment may be configured using a material (a fluorine-based resin as an example) with high mold release characteristics so that it is difficult for the toner T to become offset from the outer peripheral layer 78B.

In addition, in the heating belts 70, 70A, and 70C, CNT, CB, or graphene film are described as the respective heat-emitting bodies. However, as long as the heat-emitting body has a function of absorbing the irradiation light LB2 and emitting heat, the heat-emitting body that is included in the heating belts 70 and 70C may be a heat-emitting body other than CNT, CB, or graphene film, or may be configured by a combination of these (as one example, a heat-emitting body that is configured by a heat-emitting body that includes CNT and CB).

In addition, in the heating belts 70, 70A and 70C, description is given with the binder 72 configured using a polyimide. However, as long as the binder 72 has a function of transmitting the irradiation light LB2 and supporting the heat-emitting body, the binder 72 need not be a polyimide. For example, the binder 72 may be a fluorine resin, polycarbonate, silicon, or other resins. In addition, the binder 72 may be configured by a combination of multiple types. For example, the binder 72 may be configured by a combination that includes polyimide and a fluorine resin.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A heating body that heats a target heating body that is in contact with an outer periphery thereof, and that is formed in a tubular shape,
the heating body comprising:
a support body; and
a heat-emitting body that is supported by the support body, absorbs light that is transmitted by the support body, and emits heat.

2. The heating body according to claim 1,
wherein the heat-emitting body includes carbon nanotubes.

3. A heating device comprising:
the heating body according to claim 1, which heats particles that configure an image on a medium as target heating bodies; and
an irradiation section that irradiates the heating body with light.

4. The heating device according to claim 3,
wherein the irradiation section selectively irradiates a portion of the heating body that is in contact with the particles with light.

5. An image forming apparatus comprising:
a formation section that forms images on the medium using the particles; and
the heating device according to claim 3.
